(19) United States
(12) Patent Application Publication
(10) Pub. No.: US 2025/0283769 A1
(43) Pub. Date: Sep. 11, 2025

(54) TORQUE MEASUREMENT WITH COMPENSATION FOR STRAIN GAUGE BIAS

(71) Applicant: Apex Brands, Inc., Apex, NC (US)

(72) Inventors: Bin Sun, Shanghai (CN); Jiangming He, Shanghai (CN); Henglian Luo, Shanghai (CN)

(21) Appl. No.: 18/854,676

(22) PCT Filed: Apr. 7, 2022
(86) PCT No.: PCT/CN2022/085529

§ 371 Date: Oct. 7, 2024

(51) Int. Cl. G01L 5/24; B25B 23/142

(52) U.S. Cl. CPC G01L 5/24; B25B 23/1425

(57) ABSTRACT

An apparatus such as an electronic torque wrench (100) is provided that includes a strain gauge assembly (202), differential voltage amplifier circuit (204), analog-to-digital converter (ADC) (206) and processing circuitry (208). The strain gauge assembly (202) measures an applied torque, and produces an analog electrical signal that varies in voltage with the applied torque; and the differential voltage amplifier circuit (204) amplifies the analog electrical signal to produce an amplified analog electrical signal. The strain gauge assembly (202) has a characteristic analog signal produced without any applied torque, and the differential voltage amplifier circuit (204) is biased to a bias voltage that is calibrated to reduce the characteristic voltage in the amplified analog electrical signal. The ADC (206) converts the amplified analog electrical signal to an equivalent digital electrical signal. And the processing circuitry (208) determines the torque value of the applied torque from the equivalent digital electrical signal, and outputs an indication of the torque value.

### TECHNOLOGICAL FIELD

The present disclosure relates generally to torque application and measurement devices and, in particular, to an apparatus for torque measurement such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified torque, thereby generating a click noise.

Electronic torque wrenches tend to be more expensive than mechanical torque wrenches. When applying torque to a fastener with an electronic torque wrench, the torque readings indicated on the display device of the electronic torque wrench relate to the pretension in the fastener due to the applied torque.

Many torque wrenches use a strain gauge assembly to measure an applied torque. An ideal strain gauge assembly is balanced so that the strain gauge assembly does not produce an output without an applied torque. In many cases, however, the strain gauge assembly is not balanced; and in these cases, the strain gauge assembly has a characteristic analog signal or voltage produced by the strain gauge assembly without any applied torque. This characteristic voltage represents a bias in the strain gauge assembly in that the characteristic analog signal is the strain gauge assembly's steady state output with no excitation from an applied torque. And depending on the size of the bias, it can have a negative impact on resolution and accuracy of measurements from the strain gauge assembly and thereby the electronic torque wrench.

It would therefore be desirable to have a system and method that takes into account at least some of the issues discussed above, as well as other possible issues.

### BRIEF SUMMARY

Example implementations of the present disclosure are directed to an apparatus such as an electronic torque wrench for torque measurement with increased accuracy at lower torque values. The present disclosure includes, without limitation, the following example implementations.

Some example implementations provide an apparatus for determining a torque value of an applied torque, the apparatus comprising: a strain gauge assembly configured to measure the applied torque, and produce an analog electrical signal that varies in voltage with the applied torque, the strain gauge assembly having a characteristic analog signal produced by the strain gauge assembly without any applied torque; a differential voltage amplifier circuit configured to receive the analog electrical signal, and amplify the analog electrical signal to produce an amplified analog electrical signal, the differential voltage amplifier circuit biased to a bias voltage that is calibrated to reduce the characteristic voltage in the amplified analog electrical signal; an analog-to-digital converter configured to convert the amplified analog electrical signal to an equivalent digital electrical signal; and processing circuitry configured to determine the torque value of the applied torque from the equivalent digital electrical signal, and output an indication of the torque value.

Some example implementations provide a method of determining a torque value of an applied torque, the method comprising: measuring the applied torque using a strain gauge assembly that produces an analog electrical signal that varies in voltage with the applied torque, the strain gauge assembly having a characteristic analog signal produced by the strain gauge assembly without any applied torque; receiving the analog electrical signal at a differential voltage amplifier circuit that amplifies the analog electrical signal to produce an amplified analog electrical signal, the differential voltage amplifier circuit biased to a bias voltage that is calibrated to reduce the characteristic voltage in the amplified analog electrical signal; converting the amplified analog electrical signal to an equivalent digital electrical signal using an analog-to-digital converter; determining the torque value of the applied torque from the equivalent digital electrical signal; and outputting an indication of the torque value.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate an electronic torque wrench, according to some example implementations of the present disclosure;

FIG. 2 is a block diagram of an apparatus for determining a torque value of an applied torque, and that may correspond to the electronic torque wrench of FIG. 1, according to some example implementations;

FIG. 3 illustrates circuitry that may be used to implement various components of the apparatus of FIG. 2, according to some example implementations; and

FIGS. 4A, 4B, 4C, 4D and 4E are flowcharts illustrating various steps in a method of determining a torque value of an applied torque, according to example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

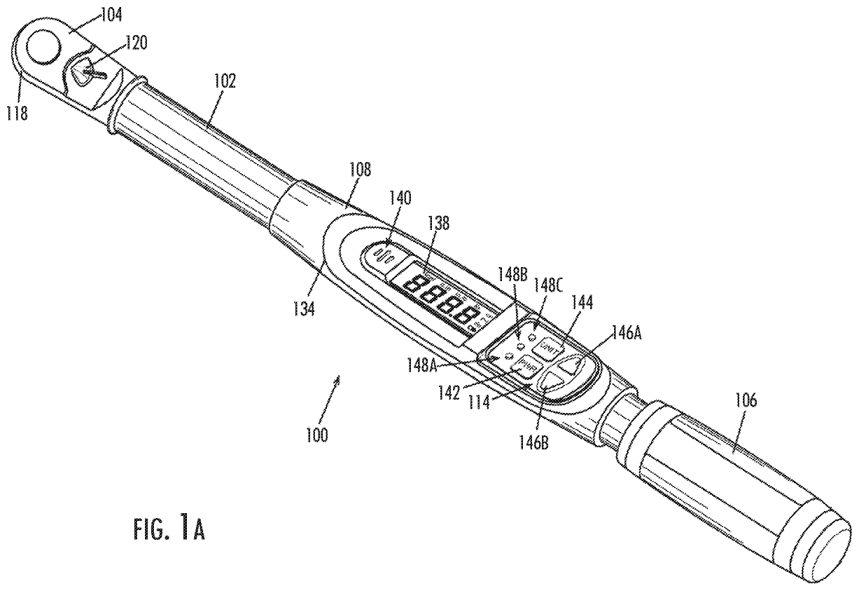

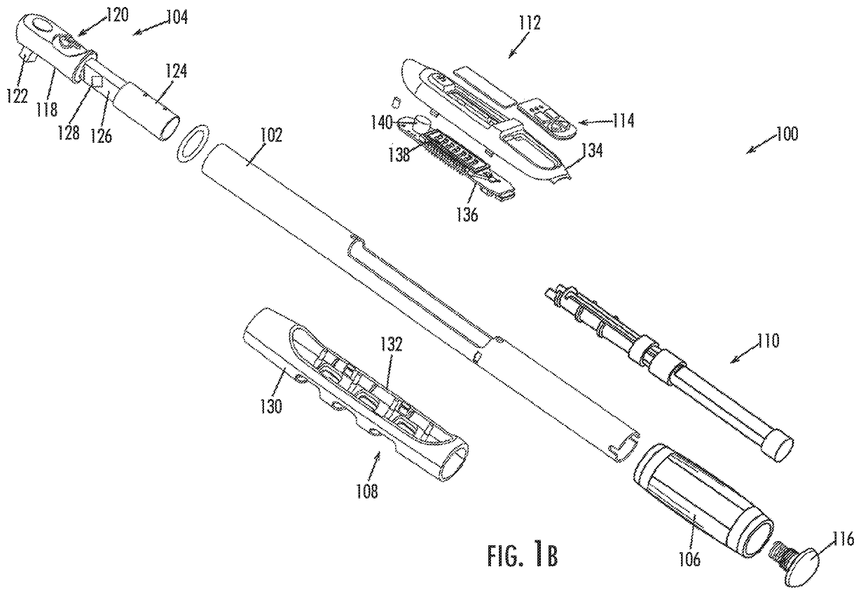

Example implementations of the present disclosure relate generally to torque application and measurement devices with increased accuracy at lower torque values. Example implementations will primarily be described in the context of an electronic torque wrench. Other examples of suitable apparatuses for torque measurement include a torque tester, torque meter, torque transducer or the like. FIGS. 1A and 1B illustrate an electronic torque wrench 100 according to some example implementations of the present disclosure. As shown, the electronic torque wrench includes a wrench body 102, a wrench head 104 (e.g., a ratcheting wrench head), a grip handle 106, a housing 108, a battery assembly 110, and an electronics unit 112 with a user interface 114. In some examples, the wrench body is of tubular construction, made of steel or other rigid material, and receives the wrench head at a first end and the battery assembly at a second end, secured therein by an end cap 116. In some of these examples, the housing is mounted therebetween and carries the electronics unit.

As shown, a front end 118 of the wrench head 104 includes a coupler with a lever 120 that allows a user to select whether torque is applied to a fastener in either a clockwise (CW) or counter-clockwise (CCW) direction. A mechanism includes a boss 122 for receiving variously sized sockets, extensions, etc. A rear end 124 of the wrench head is slidably received in the wrench body 102 and rigidly secured therein. The wrench head includes at least one vertical flat portion 126 formed between the front end and the rear end for receiving a strain gauge assembly 128. The flat portion of the wrench head is both transverse to the plane of rotation of torque wrench 100 and parallel to the longitudinal center axis of the wrench head. The strain gauge assembly includes one or more strain gauges. In some examples, the strain gauge assembly is a full-bridge assembly including four separate strain gauges on a single film that is secured to the flat portion of the wrench head. Together, the full-bridge strain gauge assembly mounted on the flat portion of the wrench head is referred to as a strain tensor.

As also shown, the housing 108 includes a bottom portion 130 that is slidably received about the wrench body 104 and defines an aperture 132 for receiving a top portion 134 that carries the electronics unit 112. The electronics unit provides the user interface 114 for the operation of the electronic torque wrench 100. The electronics unit includes a circuit board 136 including a digital display 138 and an annunciator 140 mounted thereon. The portion of the housing defines an aperture that receives the user interface, which includes a power button 142, a unit selection button 144, increment/decrement buttons 146A and 146B, and three light emitting diodes (LEDs) 148A, 148B and 148C. And the LEDs may illuminate green, yellow and red, respectively, when activated.

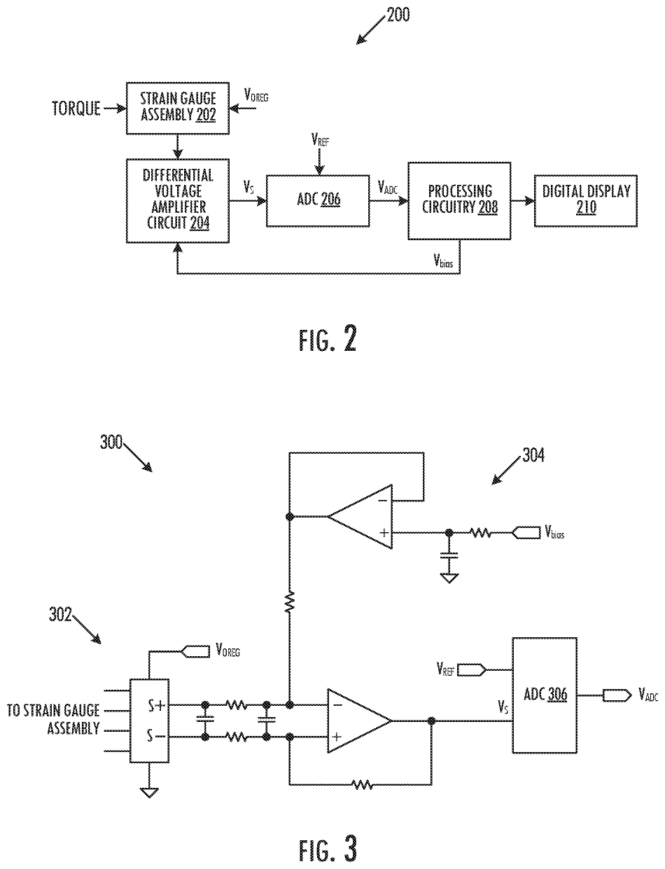

FIG. 2 illustrates an apparatus 200 for determining a torque value of an applied torque, according to some example implementations. The apparatus may be embodied in a number of different manners, and in some examples, the apparatus is an electronic torque wrench such as electronic torque wrench 100. In other examples, the apparatus is a torque tester, torque meter, torque transducer or the like. As shown, the apparatus includes a strain gauge assembly 202 (e.g., strain gauge assembly 128), a differential voltage amplifier circuit 204, an analog-to-digital converter (ADC) 206, and processing circuitry 208. In some examples in which the apparatus 200 corresponds to electronic torque wrench 100, the amplifier ADC and processing circuitry may be components of the electronics unit 112, carried by the circuit board 136.

The strain gauge assembly 202 is configured to measure the applied torque, and produce an analog electrical signal that varies in voltage with the applied torque. The differential voltage amplifier circuit 204 is configured to receive the analog electrical signal, and amplify the analog electrical signal to produce an amplified analog electrical signal.

The ADC 206 is configured to convert the amplified analog electrical signal (from the differential voltage amplifier circuit 204) to an equivalent digital electrical signal. The processing circuitry 208, then, is configured to determine the torque value of the applied torque from the equivalent digital electrical signal, and output an indication of the torque value. In some examples, the equivalent digital electrical signal includes digital data points; and in some of these examples, the processing circuitry is configured to determine a subset of the digital data points in a moving sample window, and calculate the torque value from a rolling average of the subset of the digital data points in the moving sample window.

The processing circuitry 208 may output the indication of the torque value in a number of different manners. In some examples, the apparatus 200 further includes a digital display 210 (e.g., digital display 138), and the processing circuitry is configured to output the indication of the torque value to the digital display that is configured to display the torque value.

According to example implementations of the present disclosure, the strain gauge assembly 202 has a characteristic analog signal produced by the strain gauge assembly without any applied torque. The differential voltage amplifier circuit 204, then, is biased to a bias voltage that is calibrated to reduce the characteristic voltage in the amplified analog electrical signal. In this regard, bias in the differential voltage amplifier circuit refers to its steady state output voltage with no signal applied to the differential voltage amplifier circuit. So for a bias voltage of V_{bias}, the output voltage produced by the differential voltage amplifier circuit will rest at V_{bias}, in the absence of an incoming signal. And in this regard, the characteristic voltage produced by the strain gauge assembly without any applied torque may also be viewed as bias in the strain gauge assembly.

In some examples, the characteristic analog signal is a characteristic voltage signal, and the amplified analog electrical signal for the characteristic voltage signal is an amplified voltage signal equal to a gain of the differential voltage amplifier circuit multiplied by the characteristic voltage signal, summed with the bias voltage. In this regard, consider V_{zero} as the characteristic voltage, V_{S} as the amplified voltage signal, and Gain as the gain of the differential voltage amplifier circuit. In some examples, then, amplified voltage signal may be determined as follows:

$${V}_{S} = Gain \times {V}_{zero} = {V}_{bias}$$

In some examples, the ADC 206 has a reference voltage V_{REF}. In some of these examples, the bias voltage V_{bias} of the differential voltage amplifier circuit 204 is calibrated such that the amplified analog electrical signal V_{S} is within a threshold voltage Vₜₕ of the reference voltage for the characteristic analog signal V_{zero} produced by the strain gauge assembly 202 without any applied torque. In more notional terms, the differential voltage amplifier circuit is calibrated such that (V_{REF}−Vₜₕ)<V_{S}<(V_{REF}+Vₜₕ), for the characteristic analog signal V_{zero} produced by the strain gauge assembly without any applied torque. The threshold voltage may be set in a number of different manners. The differential voltage amplifier may be calibrated such that the amplified analog electrical signal V_{S} is close to the reference voltage V_{REF}, which may then realize an equivalent digital electrical signal from the ADC that is close to zero when no torque is applied to the strain gauge assembly 202. One example of a suitable threshold voltage is 0 V. Another example of a suitable threshold is 1 mV.

In some further examples, the strain gauge assembly 202 has an excitation voltage V_{OREG} that is set to rail voltage V_{CC}, and the reference voltage V_{REF} of the ADC 206 is set to a proper fraction of the rail voltage and thereby the excitation voltage. That is, V_{REF}=k×V_{CC}=k×V_{OREG}, for k<1. In one particular example, the reference voltage V_{REF} is set to one-half of the rail voltage V_{CC} and thereby the excitation voltage V_{OREG}. In this example, k=0.5. In other suitable examples, k=0.25 or k=0.75. In some of these examples, the bias voltage Vias of the differential voltage amplifier circuit 204 is calibrated such that the amplified analog electrical signal V_{S} is within the threshold voltage Vₜₕ of the proper fraction of the excitation voltage—i.e., [(k×V_{OREG})−Vₜₕ]<V_{S}<[(k×V_{OREG})+Vₜₕ].

In some examples, the processing circuitry 208 is further configured to calibrate the bias voltage V_{bias} to which the differential voltage amplifier circuit 204 is biased. In some of these examples, calibration of the bias voltage includes the processing circuitry configured to determine a temporary bias voltage V_{bias_t}, which in some further examples may be determined as the reference voltage V_{REF} of the ADC 206. The processing circuitry may bias the differential voltage amplifier circuit to the temporary bias voltage, as the characteristic analog electrical signal is applied to the differential voltage amplifier circuit to produce the amplified analog electrical signal. The processing circuitry may then set the bias voltage V_{bias} to the temporary bias voltage V_{bias_t}, responsive to the amplified analog electrical signal being within the threshold voltage of the reference voltage.

In some further examples, the processing circuitry 208 configured to calibrate the bias voltage V/bias further includes the processing circuitry configured to determine an absolute difference between the reference voltage and the amplified analog electrical signal. In some of these examples, the amplified analog electrical signal is within the threshold voltage of the reference voltage when the absolute difference is less than the threshold voltage—i.e., |V_{REF}−V_{S}|<Vₜₕ.

In some examples, responsive to the amplified analog electrical signal not being within the threshold voltage of the reference voltage, the processing circuitry 208 is configured to adjust the temporary bias voltage, and bias the differential voltage amplifier circuit to the temporary bias voltage as adjusted, as the characteristic analog electrical signal is reapplied to the differential voltage amplifier circuit. The processing circuitry may then adjust the temporary bias voltage, and bias the differential voltage amplifier circuit to the temporary bias voltage as adjusted, until the amplified analog electrical signal is within the threshold voltage of the reference voltage.

FIG. 3 illustrates circuitry 300 that may be used to implement various components of the apparatus 200, according to some example implementations. As shown, the circuitry includes a connector 302 to connect a strain gauge assembly (e.g., strain gauge assembly 202) to a differential voltage amplifier circuit 304 that may correspond to differential voltage amplifier circuit 204. The differential voltage amplifier circuit is configured to receive a bias voltage V_{bias} to which the differential voltage amplifier circuit is biased. The circuitry also includes an ADC 308 that may correspond to ADC 206. The ADC is configured to receive the amplified analog electrical signal V_{S} from the differential voltage amplifier circuit, and the ADC has a reference voltage V_{REF}. And using V_{REF}, the ADC is configured to convert the amplified analog electrical signal to an equivalent digital electrical signal V_{ADC}, which is input to processing circuitry (e.g., processing circuitry 208).

Returning to FIG. 2, the processing circuitry 208 of example implementations of the present disclosure may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). In more particular examples, the processing circuitry may be embodied as or include a processor, coprocessor, controller, microprocessor, microcontroller, application specific integrated circuit (ASIC), field programmable gate array (FPGA) or the like.

The digital display 210 is generally any display device configured to present information in visual or tactile form. Examples of suitable digital displays include a electroluminescent (EL) display, liquid crystal display (LCD), light-emitting diode display (LED), plasma (P) display, quantum dot (QD) display and the like.

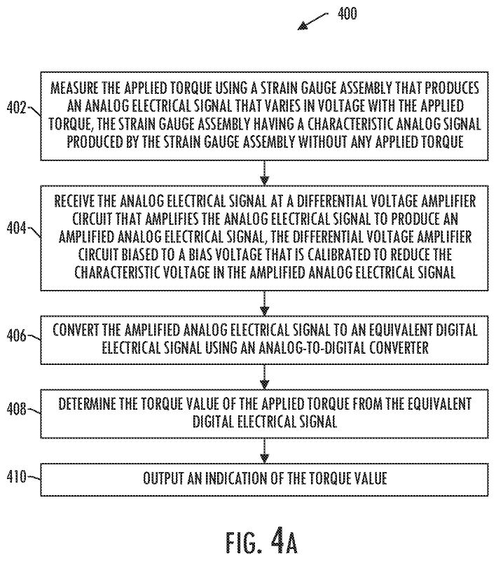

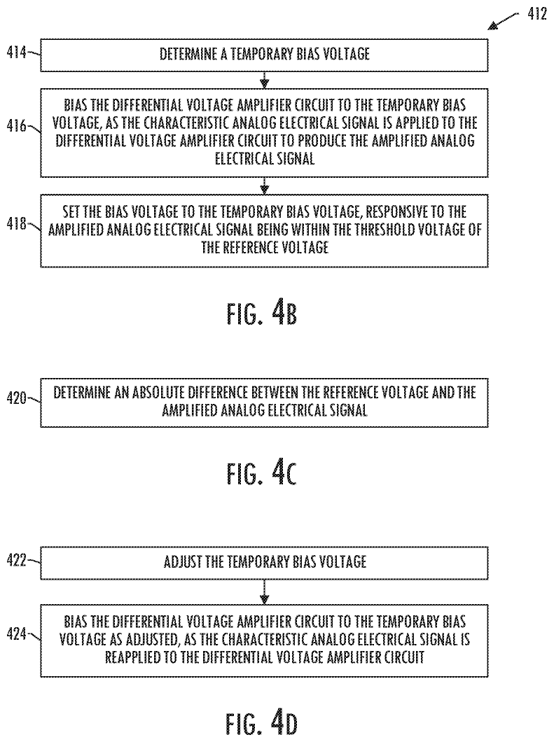

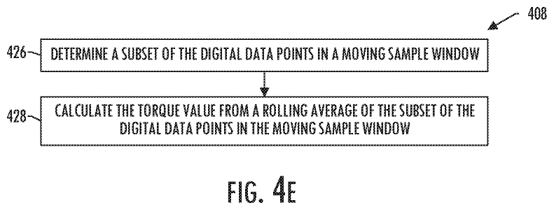

FIGS. 4A-4E are flowcharts illustrating various steps in a method 400 of determining a torque value of an applied torque, according to various example implementations of the present disclosure. The method includes measuring the applied torque using a strain gauge assembly that produces an analog electrical signal that varies in voltage with the applied torque, the strain gauge assembly having a characteristic analog signal produced by the strain gauge assembly without any applied torque, as shown at block 402 of FIG. 4A. The method includes receiving the analog electrical signal at a differential voltage amplifier circuit that amplifies the analog electrical signal to produce an amplified analog electrical signal, the differential voltage amplifier circuit biased to a bias voltage that is calibrated to reduce the characteristic voltage in the amplified analog electrical signal, as shown at block 404. The method includes converting the amplified analog electrical signal to an equivalent digital electrical signal using an analog-to-digital converter, as shown at block 406. The method includes determining the torque value of the applied torque from the equivalent digital electrical signal, as shown at block 408. And the method includes outputting an indication of the torque value, as shown at block 410.

In some examples, the characteristic analog signal is a characteristic voltage signal, and the amplified analog electrical signal for the characteristic voltage signal is an amplified voltage signal equal to a gain of the differential voltage amplifier circuit multiplied by the characteristic voltage signal, summed with the bias voltage.

In some examples, the analog-to-digital converter has a reference voltage, and the bias voltage of the differential voltage amplifier circuit is calibrated such that the amplified analog electrical signal is within a threshold voltage of the reference voltage for the characteristic analog signal produced by the strain gauge assembly without any applied torque.

In some examples, the strain gauge assembly has an excitation voltage that is set to rail voltage, and the reference voltage of the analog-to-digital converter is set to a proper fraction of the rail voltage and thereby the excitation voltage.

In some examples, the bias voltage of the differential voltage amplifier circuit is calibrated such that the amplified analog electrical signal is within the threshold voltage of the proper fraction of the excitation voltage.

In some examples, the reference voltage of the analog-to-digital converter is set to one-half of the rail voltage and thereby the excitation voltage.

In some examples, the method 400 further includes calibrating the bias voltage to which the differential voltage amplifier circuit is biased, as shown at 412 of FIG. 4B. In this regard, calibrating the bias voltage includes determining a temporary bias voltage, as shown at block at block 414. Calibrating the bias voltage includes biasing the differential voltage amplifier circuit to the temporary bias voltage, as the characteristic analog electrical signal is applied to the differential voltage amplifier circuit to produce the amplified analog electrical signal, as shown at block 416. And calibrating the bias voltage includes setting the bias voltage to the temporary bias voltage, responsive to the amplified analog electrical signal being within the threshold voltage of the reference voltage, as shown at block 418.

In some examples, the temporary bias voltage is determined at block 414 as the reference voltage of the analog-to-digital converter.

In some examples, calibrating the bias voltage further at block 412 includes determining an absolute difference between the reference voltage and the amplified analog electrical signal, as shown at block 420 of FIG. 4C. In some of these examples, the amplified analog electrical signal is within the threshold voltage of the reference voltage when the absolute difference is less than the threshold voltage.

In some examples, responsive to the amplified analog electrical signal not being within the threshold voltage of the reference voltage, calibrating the bias voltage at 412 further includes adjusting the temporary bias voltage, as shown at block 422 of FIG. 4D. Calibrating the bias voltage also further includes biasing the differential voltage amplifier circuit to the temporary bias voltage as adjusted, as the characteristic analog electrical signal is reapplied to the differential voltage amplifier circuit, as shown at block 424. In some of these examples, the temporary bias voltage is adjusted, and the differential voltage amplifier circuit is biased to the temporary bias voltage as adjusted, until the amplified analog electrical signal is within the threshold voltage of the reference voltage.

In some examples, the equivalent digital electrical signal includes digital data points, and determining the torque value at block 408 includes determining a subset of the digital data points in a moving sample window, as shown at block 426 of FIG. 4E. And determining the torque value includes calculating the torque value from a rolling average of the subset of the digital data points in the moving sample window, as shown at block 428.

In some examples, the indication of the torque value is output to a digital display that displays the torque value.

As explained above and reiterated below, the present disclosure includes, without limitation, the following example implementations.

Clause 1. An apparatus for determining a torque value of an applied torque, the apparatus comprising: a strain gauge assembly configured to measure the applied torque, and produce an analog electrical signal that varies in voltage with the applied torque, the strain gauge assembly having a characteristic analog signal produced by the strain gauge assembly without any applied torque; a differential voltage amplifier circuit configured to receive the analog electrical signal, and amplify the analog electrical signal to produce an amplified analog electrical signal, the differential voltage amplifier circuit biased to a bias voltage that is calibrated to reduce the characteristic voltage in the amplified analog electrical signal; an analog-to-digital converter configured to convert the amplified analog electrical signal to an equivalent digital electrical signal; and processing circuitry configured to determine the torque value of the applied torque from the equivalent digital electrical signal, and output an indication of the torque value.

Clause 2. The apparatus of clause 1, wherein the characteristic analog signal is a characteristic voltage signal, and the amplified analog electrical signal for the characteristic voltage signal is an amplified voltage signal equal to a gain of the differential voltage amplifier circuit multiplied by the characteristic voltage signal, summed with the bias voltage.

Clause 3. The apparatus of clause 1 or clause 2, wherein the analog-to-digital converter has a reference voltage, and the bias voltage of the differential voltage amplifier circuit is calibrated such that the amplified analog electrical signal is within a threshold voltage of the reference voltage for the characteristic analog signal produced by the strain gauge assembly without any applied torque.

Clause 4. The apparatus of clause 3, wherein the strain gauge assembly has an excitation voltage that is set to rail voltage, and the reference voltage of the analog-to-digital converter is set to a proper fraction of the rail voltage and thereby the excitation voltage.

Clause 5. The apparatus of clause 4, wherein the bias voltage of the differential voltage amplifier circuit is calibrated such that the amplified analog electrical signal is within the threshold voltage of the proper fraction of the excitation voltage.

Clause 6. The apparatus of clause 4 or clause 5, wherein the reference voltage of the analog-to-digital converter is set to one-half of the rail voltage and thereby the excitation voltage.

Clause 7. The apparatus of any of clauses 3 to 6, wherein the processing circuitry is further configured to calibrate the bias voltage to which the differential voltage amplifier circuit is biased, including the processing circuitry configured to at least: determine a temporary bias voltage; bias the differential voltage amplifier circuit to the temporary bias voltage, as the characteristic analog electrical signal is applied to the differential voltage amplifier circuit to produce the amplified analog electrical signal; and set the bias voltage to the temporary bias voltage, responsive to the amplified analog electrical signal being within the threshold voltage of the reference voltage.

Clause 8. The apparatus of clause 7, wherein the processing circuitry is configured to determine the temporary bias voltage as the reference voltage of the analog-to-digital converter.

Clause 9. The apparatus of clause 7 or clause 8, wherein the processing circuitry configured to calibrate the bias voltage further includes the processing circuitry configured to determine an absolute difference between the reference voltage and the amplified analog electrical signal, and wherein the amplified analog electrical signal is within the threshold voltage of the reference voltage when the absolute difference is less than the threshold voltage.

Clause 10. The apparatus of any of clauses 7 to 9, wherein responsive to the amplified analog electrical signal not being within the threshold voltage of the reference voltage, the processing circuitry configured to calibrate the bias voltage further includes the processing circuitry configured to: adjust the temporary bias voltage; and bias the differential voltage amplifier circuit to the temporary bias voltage as adjusted, as the characteristic analog electrical signal is reapplied to the differential voltage amplifier circuit, wherein the processing circuitry is configured to adjust the temporary bias voltage, and bias the differential voltage amplifier circuit to the temporary bias voltage as adjusted, until the amplified analog electrical signal is within the threshold voltage of the reference voltage.

Clause 11. The apparatus of any of clauses 1 to 10, wherein the equivalent digital electrical signal includes digital data points, and the processing circuitry configured to determine the torque value includes the processing circuitry configured to: determine a subset of the digital data points in a moving sample window; and calculate the torque value from a rolling average of the subset of the digital data points in the moving sample window.

Clause 12. The apparatus of any of clauses 1 to 11, wherein the processing circuitry is configured to output the indication of the torque value to a digital display configured to display the torque value.

Clause 13. A method of determining a torque value of an applied torque, the method comprising: measuring the applied torque using a strain gauge assembly that produces an analog electrical signal that varies in voltage with the applied torque, the strain gauge assembly having a characteristic analog signal produced by the strain gauge assembly without any applied torque; receiving the analog electrical signal at a differential voltage amplifier circuit that amplifies the analog electrical signal to produce an amplified analog electrical signal, the differential voltage amplifier circuit biased to a bias voltage that is calibrated to reduce the characteristic voltage in the amplified analog electrical signal; converting the amplified analog electrical signal to an equivalent digital electrical signal using an analog-to-digital converter; determining the torque value of the applied torque from the equivalent digital electrical signal; and outputting an indication of the torque value.

Clause 14. The method of clause 13, wherein the characteristic analog signal is a characteristic voltage signal, and the amplified analog electrical signal for the characteristic voltage signal is an amplified voltage signal equal to a gain of the differential voltage amplifier circuit multiplied by the characteristic voltage signal, summed with the bias voltage.

Clause 15. The method of clause 13 or clause 14, wherein the analog-to-digital converter has a reference voltage, and the bias voltage of the differential voltage amplifier circuit is calibrated such that the amplified analog electrical signal is within a threshold voltage of the reference voltage for the characteristic analog signal produced by the strain gauge assembly without any applied torque.

Clause 16. The method of clause 15, wherein the strain gauge assembly has an excitation voltage that is set to rail voltage, and the reference voltage of the analog-to-digital converter is set to a proper fraction of the rail voltage and thereby the excitation voltage.

Clause 17. The method of clause 16, wherein the bias voltage of the differential voltage amplifier circuit is calibrated such that the amplified analog electrical signal is within the threshold voltage of the proper fraction of the excitation voltage.

Clause 18. The method of clause 16 or clause 17, wherein the reference voltage of the analog-to-digital converter is set to one-half of the rail voltage and thereby the excitation voltage.

Clause 19. The method of any of clauses 15 to 18, wherein the method further comprises calibrating the bias voltage to which the differential voltage amplifier circuit is biased, including at least: determining a temporary bias voltage; biasing the differential voltage amplifier circuit to the temporary bias voltage, as the characteristic analog electrical signal is applied to the differential voltage amplifier circuit to produce the amplified analog electrical signal; and setting the bias voltage to the temporary bias voltage, responsive to the amplified analog electrical signal being within the threshold voltage of the reference voltage.

Clause 20. The method of clause 19, wherein the temporary bias voltage is determined as the reference voltage of the analog-to-digital converter.

Clause 21. The method of clause 19 or clause 20, wherein calibrating the bias voltage further includes determining an absolute difference between the reference voltage and the amplified analog electrical signal, and wherein the amplified analog electrical signal is within the threshold voltage of the reference voltage when the absolute difference is less than the threshold voltage.

Clause 22. The method of any of clauses 19 to 21, wherein responsive to the amplified analog electrical signal not being within the threshold voltage of the reference voltage, calibrating the bias voltage further includes: adjusting the temporary bias voltage; and biasing the differential voltage amplifier circuit to the temporary bias voltage as adjusted, as the characteristic analog electrical signal is reapplied to the differential voltage amplifier circuit, wherein the temporary bias voltage is adjusted, and the differential voltage amplifier circuit biased to the temporary bias voltage as adjusted, until the amplified analog electrical signal is within the threshold voltage of the reference voltage.

Clause 23. The method of any of clauses 13 to 22, wherein the equivalent digital electrical signal includes digital data points, and determining the torque value includes: determining a subset of the digital data points in a moving sample window; and calculating the torque value from a rolling average of the subset of the digital data points in the moving sample window.

Clause 24. The method of any of clauses 13 to 23, wherein the indication of the torque value is output to a digital display that displays the torque value.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for determining a torque value of an applied torque, the apparatus comprising:
a strain gauge assembly configured to measure the applied torque, and produce an analog electrical signal that varies in voltage with the applied torque, the strain gauge assembly having a characteristic analog signal produced by the strain gauge assembly without any applied torque;
a differential voltage amplifier circuit configured to receive the analog electrical signal, and amplify the analog electrical signal to produce an amplified analog electrical signal, the differential voltage amplifier circuit biased to a bias voltage that is calibrated to reduce the characteristic voltage in the amplified analog electrical signal;
an analog-to-digital converter configured to convert the amplified analog electrical signal to an equivalent digital electrical signal; and
processing circuitry configured to determine the torque value of the applied torque from the equivalent digital electrical signal, and output an indication of the torque value.

2. The apparatus of claim 1, wherein the analog-to-digital converter has a reference voltage, and the bias voltage of the differential voltage amplifier circuit is calibrated such that the amplified analog electrical signal is within a threshold voltage of the reference voltage for the characteristic analog signal produced by the strain gauge assembly without any applied torque.

3. The apparatus of claim 2, wherein the strain gauge assembly has an excitation voltage that is set to rail voltage, and the reference voltage of the analog-to-digital converter is set to a proper fraction of the rail voltage and thereby the excitation voltage.

4. The apparatus of claim 3, wherein the bias voltage of the differential voltage amplifier circuit is calibrated such that the amplified analog electrical signal is within the threshold voltage of the proper fraction of the excitation voltage.

5. The apparatus of claim 3, wherein the reference voltage of the analog-to-digital converter is set to one-half of the rail voltage and thereby the excitation voltage.

6. The apparatus of claim 2, wherein the processing circuitry is further configured to calibrate the bias voltage to which the differential voltage amplifier circuit is biased, including the processing circuitry configured to at least:
determine a temporary bias voltage;
bias the differential voltage amplifier circuit to the temporary bias voltage, as the characteristic analog electrical signal is applied to the differential voltage amplifier circuit to produce the amplified analog electrical signal; and
set the bias voltage to the temporary bias voltage, responsive to the amplified analog electrical signal being within the threshold voltage of the reference voltage.

7. The apparatus of claim 6, wherein the processing circuitry is configured to determine the temporary bias voltage as the reference voltage of the analog-to-digital converter.

8. The apparatus of claim 6, wherein the processing circuitry configured to calibrate the bias voltage further includes the processing circuitry configured to determine an absolute difference between the reference voltage and the amplified analog electrical signal, and
wherein the amplified analog electrical signal is within the threshold voltage of the reference voltage when the absolute difference is less than the threshold voltage.

9. The apparatus of claim 6, wherein responsive to the amplified analog electrical signal not being within the threshold voltage of the reference voltage, the processing circuitry configured to calibrate the bias voltage further includes the processing circuitry configured to:
adjust the temporary bias voltage; and
bias the differential voltage amplifier circuit to the temporary bias voltage as adjusted, as the characteristic analog electrical signal is reapplied to the differential voltage amplifier circuit,
wherein the processing circuitry is configured to adjust the temporary bias voltage, and bias the differential voltage amplifier circuit to the temporary bias voltage as adjusted, until the amplified analog electrical signal is within the threshold voltage of the reference voltage.

10. The apparatus of claim 1, wherein the equivalent digital electrical signal includes digital data points, and the processing circuitry configured to determine the torque value includes the processing circuitry configured to:
determine a subset of the digital data points in a moving sample window; and
calculate the torque value from a rolling average of the subset of the digital data points in the moving sample window.

11. A method of determining a torque value of an applied torque, the method comprising:
measuring the applied torque using a strain gauge assembly that produces an analog electrical signal that varies in voltage with the applied torque, the strain gauge assembly having a characteristic analog signal produced by the strain gauge assembly without any applied torque;
receiving the analog electrical signal at a differential voltage amplifier circuit that amplifies the analog electrical signal to produce an amplified analog electrical signal, the differential voltage amplifier circuit biased to a bias voltage that is calibrated to reduce the characteristic voltage in the amplified analog electrical signal;
converting the amplified analog electrical signal to an equivalent digital electrical signal using an analog-to-digital converter;
determining the torque value of the applied torque from the equivalent digital electrical signal; and
outputting an indication of the torque value.

12. The method of claim 11, wherein the analog-to-digital converter has a reference voltage, and the bias voltage of the differential voltage amplifier circuit is calibrated such that the amplified analog electrical signal is within a threshold voltage of the reference voltage for the characteristic analog signal produced by the strain gauge assembly without any applied torque.

13. The method of claim 12, wherein the strain gauge assembly has an excitation voltage that is set to rail voltage, and the reference voltage of the analog-to-digital converter is set to a proper fraction of the rail voltage and thereby the excitation voltage.

14. The method of claim 13, wherein the bias voltage of the differential voltage amplifier circuit is calibrated such that the amplified analog electrical signal is within the threshold voltage of the proper fraction of the excitation voltage.

15. The method of claim 13, wherein the reference voltage of the analog-to-digital converter is set to one-half of the rail voltage and thereby the excitation voltage.

16. The method of claim 12, wherein the method further comprises calibrating the bias voltage to which the differential voltage amplifier circuit is biased, including at least:
determining a temporary bias voltage;
biasing the differential voltage amplifier circuit to the temporary bias voltage, as the characteristic analog electrical signal is applied to the differential voltage amplifier circuit to produce the amplified analog electrical signal; and
setting the bias voltage to the temporary bias voltage, responsive to the amplified analog electrical signal being within the threshold voltage of the reference voltage.

17. The method of claim 16, wherein the temporary bias voltage is determined as the reference voltage of the analog-to-digital converter.

18. The method of claim 16, wherein calibrating the bias voltage further includes determining an absolute difference between the reference voltage and the amplified analog electrical signal, and
wherein the amplified analog electrical signal is within the threshold voltage of the reference voltage when the absolute difference is less than the threshold voltage.

19. The method of claim 16, wherein responsive to the amplified analog electrical signal not being within the threshold voltage of the reference voltage, calibrating the bias voltage further includes:
adjusting the temporary bias voltage; and
biasing the differential voltage amplifier circuit to the temporary bias voltage as adjusted, as the characteristic analog electrical signal is reapplied to the differential voltage amplifier circuit,
wherein the temporary bias voltage is adjusted, and the differential voltage amplifier circuit biased to the temporary bias voltage as adjusted, until the amplified analog electrical signal is within the threshold voltage of the reference voltage.

20. The method of claim the differential voltage amplifier circuit, wherein the equivalent digital electrical signal includes digital data points, and determining the torque value includes:
determining a subset of the digital data points in a moving sample window; and
calculating the torque value from a rolling average of the subset of the digital data points in the moving sample window.
